(19) United States
(12) Patent Application Publication
(10) Pub. No.: US 2011/0288453 A1
(43) Pub. Date: Nov. 24, 2011

(54) WALKING MOTION ASSISTING DEVICE

(75) Inventor: Yosuke Endo, Wako-shi (JP)

(73) Assignee: HONDA MOTOR CO., LTD., Tokyo (JP)

(21) Appl. No.: 13/111,479

(22) Filed: May 19, 2011

(30) Foreign Application Priority Data
May 20, 2010 (JP) 2010-116651

(51) Int. Cl. A61H 1/02

(52) U.S. Cl. 601/35

(57) ABSTRACT

A device capable of assisting an agent in taking a step even in the case where the leg motion of the agent is stagnant. It is determined whether the agent is in a first state in which the leg of the agent is moving or in a second state in which the leg of the agent is stagnant, on the basis of a value detected in response to the leg motion of the agent. If a transition from the first state to the second state is detected as the determination result, a value of a sustained energy input term is increased, where the sustained energy input term is contained in a simultaneous differential equation representing a second model for use in generating a second oscillator ξ₂, which is to be a control basis of an assisting force.

### BACKGROUND OF THE INVENTION

1. Field of the Invention

The present invention relates to a device for assisting an agent in walking motion with the motion of the legs of the agent by causing the force of an actuator to act on the legs via orthoses attached to the legs of the agent.

2. Description of the Related Art

In some cases, a human is not able to start walking or to take a step forward in accordance with his/her wishes due to physical deconditioning or disease. For example, a symptom known as “freezing of gait” observed in Parkinson's disease patients or the like corresponds to the above cases.

Therefore, there have been suggested technical approaches for giving a visual or auditory stimulation to an agent (doer) by causing a sign to appear in front of the agent, causing the agent to listen to a sound, or the like (Refer to Japanese Patent No. 3109052, Japanese Patent Application Laid-Open No. 2009-119066, Japanese Patent Application Laid-Open No. 2009-102156, and Japanese Patent No. 4019119). According to the approaches, the symptom of freezing of gait is relieved by causing the agent to be aware of taking a step.

### SUMMARY OF THE INVENTION

It is, however, often difficult for an agent to take a step actually only by causing the agent to be aware of taking a step.

Therefore, it is an object of the present invention to provide a device capable of assisting an agent in taking a step even if the motion of a leg of the agent is stagnant.

The present invention relates to a device having a first orthosis and a second orthosis attached to the body and thigh of an agent, respectively, an actuator, and a controller, which controls the amplitude and phase of an output from the actuator, the walking motion assisting device assisting the agent in walking motion by assisting a motion around a hip joint of the thigh relative to the body of the agent via the first orthosis and the second orthosis by the output from the actuator.

In order to achieve the above object, the present invention provides a walking motion assisting device, wherein the controller includes: a motion oscillator detecting element configured to detect an oscillation signal that changes with time in response to a periodic motion of a leg of the agent, as a second motion oscillator; a second oscillator generating unit configured to generate a second oscillator as an output oscillation signal by inputting, as an input oscillation signal, the second motion oscillator detected by a motion oscillator detecting element to a second model, which is defined by a simultaneous differential equation having a plurality of state variables representing a motion state of the agent to generate the output oscillation signal that changes with time according to an amplitude corresponding to a value of a sustained energy input term contained in the simultaneous differential equation and an angular velocity determined based on a second intrinsic angular velocity, on the basis of the input oscillation signal; a control command signal generating element, which generates a control command signal to the actuator on the basis of the second oscillator; a state monitoring element configured to determine whether the agent is in a first state in which the agent is moving the leg or a second state in which a leg motion of the agent is stagnant according to whether an index value remains within a specified range over time longer than a specified time period where the index value is a value detected by a sensor in response to the leg motion of the agent; and an energy adjusting element configured to increase the value of the sustained energy input term with a requirement that the determination result obtained by the state monitoring element indicates a transition from the first state to the second state.

According to the walking motion assisting device of the present invention, the oscillation signal that changes with time in response to the leg motion of the agent is detected as a second motion oscillator. Moreover, the second motion oscillator is input to the second model, by which the second oscillator is generated. Then, the control command signal is generated based on the second oscillator and the operation of the actuator is controlled according to the control command signal.

This enables the control of a force for assisting the leg motion of the agent while maintaining harmonization between a motion cycle or a rate of phase change of the leg of the agent and an operation cycle or a rate of phase change of the actuator.

Further, it is determined whether the agent is in the first state in which the leg of the agent is moving or the second state in which the leg motion of the agent is stagnant on the basis of the value detected in response to the leg motion of the agent. If the transition from the first state to the second state is detected as the determination result, the value of the sustained energy input term is increased, where the sustained energy input term is contained in the simultaneous differential equation representing the second model.

This intensifies the output from the actuator for use in assisting the leg motion in response to that the leg motion of the agent is stagnant due to freezing of gait or the like. Therefore, even if the motion of a leg of the agent is stagnant, the walking motion assisting device is able to assist the agent in taking a step with the leg.

The state monitoring element may be configured to further determine whether the agent took a step. In the case where the determination result obtained by the state monitoring element indicates the transition from the first state to the second state, the energy adjusting element may be configured to increase the value of the sustained energy input term continuously or stepwise until the state monitoring element determines that the agent took a step.

According to the walking motion assisting device having the above configuration, the force for assisting the leg motion is intensified continuously or stepwise during a time period after the leg motion of the agent is stopped and until the agent takes a step with the leg. This inhibits a rapid change of the force for assisting the leg motion of the agent, thereby avoiding a situation where the agent feels uncomfortable about the operation of the walking motion assisting device. In addition, the leg motion of the agent is able to be assisted with a force having just enough strength for the agent to take a step forward in moving the stagnant leg.

The energy adjusting element may be configured to decrease the value of the sustained energy input term with a requirement that the determination result obtained by the state monitoring element indicates a transition from the second state to the first state.

According to the walking motion assisting device having the above configuration, the force for assisting the leg motion is intensified as described above after the leg motion of the agent is stagnant and the force is reduced after the agent moves the leg again. This avoids a situation where the leg motion of the agent is assisted more than necessary by the output from the actuator.

The state monitoring element may be configured to further determine whether the agent took a step and the energy adjusting element may be configured to decrease the value of the sustained energy input term stepwise every time the state monitoring element determines that the agent took a step.

According to the walking motion assisting device having the above configuration, the agent moves a leg as described above and the force for assisting the leg motion is reduced stepwise every time the agent takes a step with the leg. This inhibits a rapid change of the force for assisting the leg motion of the agent, thereby avoiding a situation where the agent feels uncomfortable about the operation of the walking motion assisting device.

The energy adjusting element may be configured so that under the condition that a time interval between the last time's clock time and the current time's clock time when the agent took a step is less than the specified time period, the longer the time interval is, the less the value of the sustained energy input term is decreased.

According to the walking motion assisting device having the above configuration, an excessive reduction of the force for assisting the leg motion is avoided in a situation where it is presumed that the agent has trouble in taking a step. This enables the assistance for the leg motion to be continued with a force having appropriate strength for the agent to take a step in that situation.

The walking motion assisting device may further include a guidance signal output device, which outputs a signal recognizable by at least one of five senses of the agent or an electrical stimulation signal as a guidance signal. Furthermore, the motion oscillator detecting element may be configured to detect an oscillation signal that changes with time in response to the periodic motion of the leg of the agent, as a first motion oscillator, and the controller may include: a first oscillator generating element configured to generate a first oscillator as an output oscillation signal by inputting, as the input oscillation signal, the first motion oscillator detected by the motion oscillator detecting element to a first model for generating the output oscillation signal, which oscillates at an angular velocity determined based on a first intrinsic angular velocity by mutual entrainment with the input oscillation signal; a intrinsic angular velocity setting element configured to set an angular velocity of a second virtual oscillator as the second intrinsic angular velocity so that the second phase difference approximates to a desired phase difference according to a virtual model representing a first virtual oscillator and the second virtual oscillator, which oscillate with a second phase difference while interacting with each other on the basis of a first phase difference representing a correlation between the phase polarity of the first motion oscillator detected by the motion oscillator detecting element and the phase polarity of the first oscillator generated by the first oscillator generating unit; and a motion guidance control element configured to cause the guidance signal output device to output the guidance signal intermittently in synchronization with a change with time of the first oscillator generated by the first oscillator generating element.

According to the walking motion assisting device having the above configuration, the oscillation signal that changes with time in response to the leg motion of the agent is detected as the first motion oscillator. The first motion oscillator may be either the same as or different from the second motion oscillator. Moreover, the input of the first motion oscillator to the first model causes the generation of the first oscillator. Then, the guidance signal is output in synchronization with the first oscillator.

This enables the agent to be aware of walking motion with the periodic motion of the leg of the agent or encourages the agent to perform the walking motion. Therefore, even if the motion of a leg of the agent is stagnant, the walking motion assisting device is able to assist the agent while encouraging the agent to take a step with the leg.

The walking motion assisting device may further include a guidance signal output device, which outputs a signal recognizable by at least one of five senses of the agent or an electrical stimulation signal as a guidance signal, and the controller may include a motion guidance control element configured to cause the guidance signal output device to output the guidance signal intermittently in synchronization with a change with time of the second oscillator generated by the second oscillator generating element.

According to the walking motion assisting device having the above configuration, the guidance signal is output in synchronization with the second oscillator. This enables the agent to be aware of walking motion with the periodic motion of each leg of the agent or encourages the agent to perform the walking motion. Therefore, even if the motion of a leg of the agent is stagnant, the walking motion assisting device is able to assist the agent while encouraging the agent to take a step with the leg.

### BRIEF DESCRIPTION OF THE DRAWINGS

FIG. 1 is a structural view of a walking motion assisting device as one embodiment of the present invention;

FIG. 2 is a block view illustrating a controller of the walking motion assisting device;

FIG. 3 is a flow chart illustrating a control process of the walking motion assisting device;

FIG. 4 is a flow chart illustrating a control process of an assisting force of the walking motion assisting device;

FIG. 5 (a) to FIG. 5(c) are explanatory diagrams related to a control process of a motion assisting factor of the walking motion assisting device; and

FIG. 6 (a) to FIG. 6(b) are explanatory diagrams related to an output control process of a guidance signal.

### DESCRIPTION OF THE PREFERRED EMBODIMENTS

Preferred embodiments of a walking motion assisting device according to the present invention will be described with reference to accompanying drawings. Hereinafter, references L and R are used to distinguish between the left and right of the legs or the like. The references, however, are omitted in case there is no need to distinguish between the left and right or in case a vector having left and right components is represented. In addition, signs “+” and “−” are used to distinguish between the bending motion (forward motion) and the stretching motion (backward motion) of a leg (specifically, thigh).

(Configuration of Walking Motion Assisting Device)

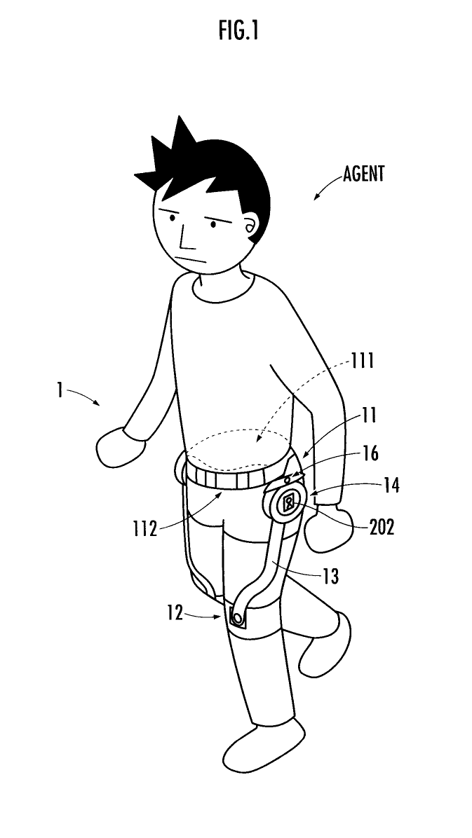

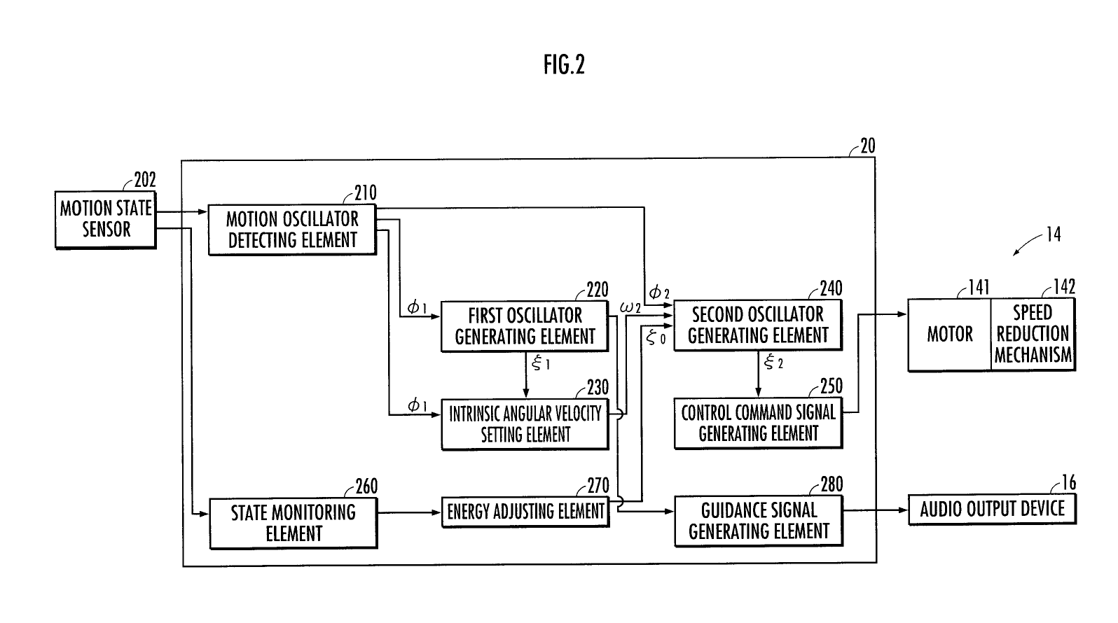

The walking motion assisting device 1 illustrated in FIG. 1 has a first orthosis 11, a second orthosis 12, an actuator 14, and an audio output device 16. As illustrated in FIG. 2, the walking motion assisting device 1 has a motion state sensor 202 and a controller 20.

The first orthosis 11 has a hip pad 111, which is pressed against the back side of the waist of an agent (a human as a doer) and a band 112 wrapped around the abdomen to fix the hip pad to the waist. The hip pad 111 is made of, for example, semihard resin having flexibility. An actuator 14 is fit to a lower end portion on each of the left and right sides of the hip pad 111 with a rotational degree of freedom around the roll axis.

The second orthosis 12 has a band able to be wrapped around the thigh of the leg of the agent. The second orthosis 12 has a link member 13 for transmitting an output from the actuator 14 to the second orthosis 12 fit to the front side of the thigh with a rotational degree of freedom around the roll axis. The link member 13 is made of hard resin and is formed in a shape of curving toward the front side of each of the left and right thighs from each of the left and right sides of the waist of the agent.

The controller 20 is composed of a computer (including the CPU, ROM, RAM, I/O circuits, A/D converter circuit, or the like) embedded in the hip pad 111 of the first orthosis 11. The controller 20 controls the operation of the actuator 14 by performing arithmetic processing according to a program read out appropriately from a memory on the basis of an output signal from the motion state sensor 202.

The controller 20 includes a motion oscillator detecting element 210, a first oscillator generating element 220, an intrinsic angular velocity setting element 230, a second oscillator generating element 240, a control command signal generating element 250, a state monitoring element 260, an energy adjusting element 270, and a guidance signal generating element 280. The elements are configured or programmed to perform arithmetic processing described later. The elements may be composed of partially or entirely common hardware resources.

The actuator 14 has a motor 141 and a speed reduction mechanism 142. The controller 20 controls the operation of the motor 141 and the reduction ratio of the speed reduction mechanism 142. An output from the motor 141 through the speed reduction mechanism 142 corresponds to an output from the actuator 14. The output from the actuator 14 is transmitted to the waist of the agent via the first orthosis 11 and to the leg (directly to the thigh) of the agent via the link member 13 and the second orthosis 12.

The motion state sensor 202 is configured to output a signal corresponding to a value of a motion state variable of the agent. For example, a rotary encoder disposed on each of the left and right sides of the waist of the agent, which outputs a signal corresponding to a relative angle (hereinafter, referred to as “hip joint angle”) of the waist and thigh (leg) of the agent, corresponds to the motion state sensor 202. Besides, when the rotor angle of the motor constituting the actuator 14 is a basis for calculating the leg angle, a hall element provided on the motor to output a signal corresponding to the rotor angle may be used as a motion state sensor 202.

(Functions of Walking Motion Assisting Device)

The following describes a method of assisting the agent in walking motion by using the walking motion assisting device 1 having the above configuration.

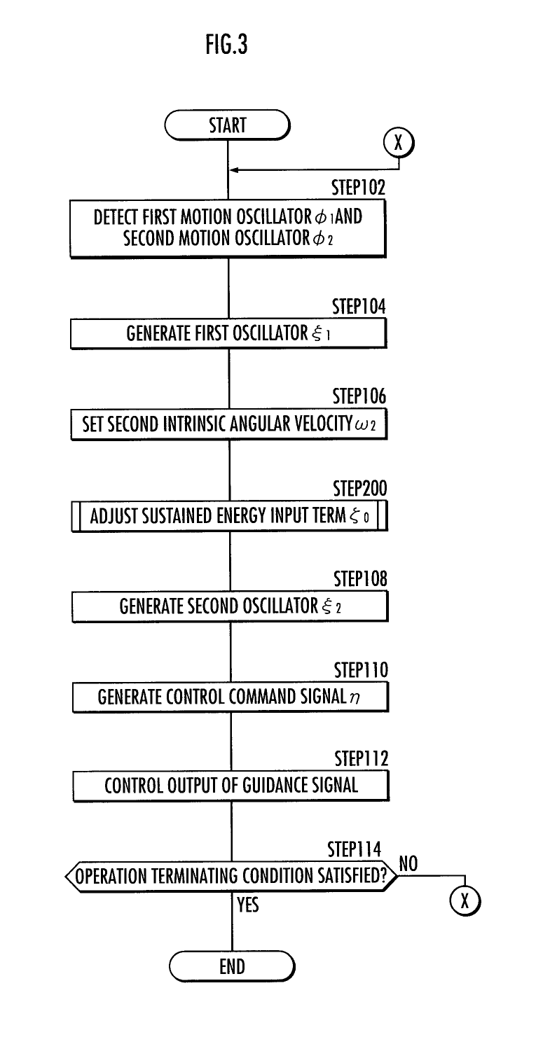

First, the motion state detecting element 210 detects a first motion oscillator φ₁ and a second motion oscillator φ₂ on the basis of an output from the first motion state sensor S1 (FIG. 3, STEP 102). The first motion oscillator φ₁ is an oscillation signal representing a change mode of left and right hip joint angular velocities (dψ_{L}/dt, dψ_{R}/dt) of the agent. The second motion oscillator φ₂ is an oscillation signal representing a change mode of left and right hip joint angles (ψ_{L}, ψ_{R}) of the agent.

A motion detecting element 220 receives an output signal from the motion state sensor 202 on a sampling-period or arithmetic-operation-period basis and calculates a hip joint angular velocity, which is a hip joint angle of the agent and a first-order time derivative thereof.

The first motion oscillator φ₁ and the second motion oscillator φ₂ may be the same as each other, such that both are hip joint angles or hip joint angular velocities. The first motion oscillator φ₁ may be a hip joint angle and the second motion oscillator φ₂ may be a hip joint angular velocity. An arbitrary combination of the left and right shoulder joint angle and angular velocity may be detected as the first motion oscillator φ₁ and the second motion oscillator φ₂. Floor reaction forces acting on the left and right legs of the agent may be detected as the first motion oscillator φ₁ and the second motion oscillator φ₂.

Each of the left hip joint angular velocity dψ_{L}/dt and the right hip joint angular velocity dψ_{R}/dt, which are components of a two-dimensional vector φ₁, periodically changes almost in antiphase according to a periodic motion of each of the left thigh and the right thigh, which are two symmetrical body parts of the agent, relative to the waist. Similarly, each of the left hip joint angle ψ_{L} and the right hip joint angle ψ_{R}, which are components of a two-dimensional vector φ₂, periodically changes almost in antiphase according to the periodic motion of each of the left thigh and the right thigh of the agent relative to the waist.

Further, the first oscillator generating element 220 generates a first oscillator ξ₁=(ξ_{1L}, ξ_{1R}) in response to an input of a first motion oscillator φ₁, which has been measured by the motion oscillator detecting element 210, into a first model (FIG. 3, STEP 104).

The first model generates an output oscillation signal that oscillates at an angular velocity determined based on a first intrinsic angular velocity ω₁=(ω_{1L}, Ω_{1R}) by mutual entrainment with an input oscillation signal. The first model is expressed using the van der Pol equation represented by the following expression (010):

(d²ξ_{1L}/dt²)=χ(1−ξ_{1L}²)(dξ_{1L}/dt)−ω_{1L}²ξ_{1L}+g(ξ_{1L}−ξ_{1R})+K₁φ_{1L},

(d²ξ_{1R}/dt²)=χ(1−ξ_{1R}²)(dξ_{1R}/dt)−ω_{1R}²ξ_{1R}+g(ξ_{1R}−ξ_{1L})+K₁φ_{1R} (10)

where “χ” is a positive coefficient set so that the first oscillator ξ₁ and its first-order time derivative (dξ₁/dt) forms a stable limit cycle on a ξ₁−(dξ₁/dt) plane, “g” is a first correlation coefficient for use in reflecting the correlation between the motions of the left and right legs in the first model, and “K₁” is a feedback coefficient. The first intrinsic angular velocity ω₁ is able to be arbitrarily set within a range that does not greatly deviate from an angular velocity that determines the phase change mode of the operation of the walking motion assisting device 1.

The first oscillator ξ₁=(ξ_{1L}, ξ_{1R}) is calculated using the Runge-Kutta method. The first oscillator ξ₁ oscillates at an angular velocity determined based on the first intrinsic angular velocity ω₁ while harmonizing with the angular velocity of the first motion oscillator φ₁ that changes with time at substantially the same period as the period of the motion of the agent by the mutual entrainment, which is one of the properties of a van del Pol equation.

Besides using the van del Pol equation (010), the first model may be represented by an arbitrary equation able to generate an output oscillation signal that changes with time at an angular velocity harmonizing with the angular velocity of the first motion oscillator φ₁ by mutually entraining with the first motion oscillator φ₁, which is the input oscillation signal.

According to the first model, even in the case where the first motion oscillator φ₁ does not change with time substantially at all because the leg motion of the agent is stagnant, it is possible to generate the first oscillator ξ₁ that oscillates at an angular velocity determined based on the first intrinsic angular velocity ω₁ or changes in phase.

Moreover, the intrinsic angular velocity setting element 230 sets a second intrinsic angular velocity ω₂ on the basis of the first motion oscillator φ₁ detected by the motion oscillator detecting element 210 and the first oscillator ξ₁ generated by the first oscillator generating element 220 (FIG. 3, STEP 106). The current time's set value of the second intrinsic angular velocity ω₂ is used as the first intrinsic angular velocity ω₁ at the next setting of the first oscillator ξ₁ (See the expression (010)).

Specifically, with respect to the left and right components, the first phase difference δθ₁ is calculated according to a relational expression (021), which represents a correlation between the phase polarity of the first motion oscillator φ₁ and the phase polarity of the first oscillator ξ₁:

δθ₁=∫dt·δθ(φ₁, ξ₁),

δθ(φ₁, ξ₁)≡sgn(ξ₁){sgn(φ₁)−sgn(dξ₁/dt)},

sgn(θ)≡−1(θ<0), 0(θ=0) or 1(θ>0) (021)

Next, a second phase difference δθ₂ is calculated according to a virtual model with a requirement that the first phase difference δθ₁ is constant over the past three walking periods. According to the virtual model, relational expressions (022) and (023) represent the correlation between a virtual motion oscillator θₕ and a virtual control command signal θₘ. The second phase difference δθ₂ is calculated according to a relational expression (024):

(dθₕ/dt)=ωₕ+ε sin(θₘ−θₕ) (022)

(dθₘ/dt)=ωₘ+ε sin(θₕ−θₘ) (023)

δθ₂=arcsin[(ωₕ−ωₘ)/2ε] (024)

where “ε” is a correlation coefficient between the virtual motion oscillator θₕ and the virtual control command signal θₘ, “ωₕ” is an angular velocity of the virtual motion oscillator θₕ, and “ωₘ” is an angular velocity of the virtual control command signal θₘ.

Subsequently, a correlation coefficient ε is set so as to minimize a difference between the first phase difference δθ₁ and the second phase difference δθ₂. Specifically, a correlation coefficient ε at time {tᵢ|i=1, 2, . . . } when the first motion oscillator φ₁ equals zero and satisfies dφ₁/dt>0 with respect to the left and right components is sequentially set according to a relational expression (025).

ε(tᵢ₊₁)=ε(tᵢ)−η{V(tᵢ₊₁)−V(tᵢ)}/{ε(tᵢ)−ε(tᵢ₋₁)},

V(tᵢ₊₁)≡(½){δθ₁(tᵢ₊₁)−δθ₂(tᵢ)}² (025)

η=(η_{L}, η_{R}) is a coefficient representing the stability of a potential V=(V_{L}, V_{R}) that approximates the left and right components of the first phase difference δθ₁ to the left and right components of the second phase difference δθ₂.

Then, the angular velocity ωₕ of the virtual motion oscillator θₕ is calculated according to a relational expression (026) by using a coefficient α=(α_{L}, α_{R}) representing the stability of a system so as to minimize the left and right components of a difference δθ₁−δθ₂ between the first phase difference and the second phase difference under the condition that the angular velocity ωₘ of the virtual control command signal θₘ is constant on the basis of the correlation coefficient ε.

ωₕ(tᵢ)=−α∫dt·([4ε(tᵢ)²−{ωₕ(t)−ωₘ(tᵢ)}²]^{1/2}×sin[arcsin{(ωₕ(t)−ωₘ(tᵢ₋₁))2ε(tᵢ)}−δθ₁(tᵢ)]) (026)

Subsequently, the angular velocity ωₘ of the virtual control command signal θₘ is set as a second intrinsic angular velocity ω₂ with respect to the left and right components on the basis of the angular velocity ωₕ of the virtual motion oscillator θ_{H}. More specifically, the angular velocity ωₘ =(ω_{mL}, ω_{mR}) of the virtual control command signal θₘ is set according to a relational expression (027) by using a coefficient β=(β_{L}, β_{R}) representing the stability of a system so that the second phase difference δθ₂ approximates to the desired phase difference δθ₀ with respect to the left and right components.

ωₘ(tᵢ)=β∫dt·([4ε(tᵢ)²−{ωₕ(tᵢ)−ωₘ(t)}²])×sin[arcsin{(ωₕ(tᵢ)−ωₘ(t))/2ε(tᵢ)}−δθ₀]) (027)

The energy adjusting element 270 adjusts the value of a sustained energy input term ζ₀ (FIG. 3, STEP 200). The sustained energy input term ζ₀ and a method of controlling the value thereof will be described later.

Subsequently, the second oscillator generating element 240 generates a second oscillator ξ₂=(ξ_{2L+}, ξ_{2L-}, ξ_{2R+}, ξ_{2R-}) according to the second model on the basis of the second motion oscillator φ₂ detected by the motion oscillator detecting element 210, the second intrinsic angular velocity ω₂ set by the intrinsic angular velocity setting element 230, and the sustained energy input term ζ₀ set by the energy adjusting element 270 (FIG. 3, STEP 108).

The second model is defined by a simultaneous differential equation having a plurality of state variables representing the motion state of the agent to generate an output oscillation signal that changes with time according to an amplitude corresponding to a value of the sustained energy input term ζ₀ contained in the simultaneous differential equation and an angular velocity determined based on the second intrinsic angular velocity ω₂, on the basis of the input oscillation signal.

The second model is defined by, for example, the following simultaneous differential equation (030):

τ_{1L}+(du_{L+}/dt)=c_{L+}ζ_{0L+}−u_{L+}+w_{L+/L-}ξ_{2L-}+w_{L+/R+}ξ_{2R+}−λ_{L}v_{L+}+f₁(ω_{2L})+f₂(ω_{2L})K₂φ_{2L},

τ_{1L}−(du_{L-}/dt)=c_{L-}ζ_{0L-}−u_{L-}−w_{L-/L+}ξ_{2L+}+w_{L-/R-}ξ_{2R-}−λ_{L}v_{L-}+f₁(ω_{2L})+f₂(ω_{2L})K₂φ_{2L},

τ_{1R}+(du_{R+}/dt)=c_{R+}ζ_{0R+}−u_{R+}+w_{R+/L+}ξ_{2R-}+w_{R+/R+}ξ_{2R+}−λ_{R}v_{R+}+f₁(ω_{2R})+f₂(ω_{2R})K₂φ_{2R},

τ_{1R}−(du_{R-}/dt)=c_{R-}ζ_{0R-}−u_{R-}−w_{R-/R-}ξ_{2L+}+w_{R-/R-}ξ_{2R-}−λ_{R}v_{R-}+f₁(ω_{2R})+f₂(ω_{2R})K₂φ_{2R},

τ₂ᵢ(dvᵢ/dt)=−v₂ᵢ+ξ₂ᵢ(i=L+, L−, R+, R−)

ξ₂ᵢ=H(uᵢ−uₜₕ)=0(uᵢ<ᵤₜₕ) or uᵢ(uᵢ≧uₜₕ), or

ξ₂ᵢ=fs(uᵢ)=uᵢ/(1+exp(−uᵢ/D)) (030)

The simultaneous differential equation (030) contains therein the state variables uᵢ representing the behavior state (identified by an amplitude and a phase) of each thigh in the bending direction (forward) and the stretching direction (backward), respectively, and a self-control factor vᵢ representing the adaptability of each behavior state. Moreover, the simultaneous differential equation (030) contains therein a coefficient cᵢ related to the sustained energy input term ζ₀.

The first time constant τ₁ᵢ is a time constant that specifies the variation characteristics of the state variable uᵢ and is represented by a relational expression (031) by using a ω₂-dependent coefficient τ(ω₂) and a constant γ=(γ_{L}, γ_{R}). The first time constant τ₁ᵢ, varies in dependence on the second intrinsic angular velocity ω₂.

τ_{1L+}=τ_{1L-}=(t(ω_{2L})/ω_{2L})−γ_{L}, τ_{1R+}=τ_{1R-}=(t(ω_{2R})/ω_{2R})−γ_{R} (031)

The second time constant τ₂ᵢ is a time constant that specifies the variation characteristics of the self-control factor vᵢ, “w_{i/j}” is a negative second correlation coefficient for use in representing the correlation between the state variables uᵢ and uⱼ, which represent the motions of the left and right legs of the agent in the bending direction and in the stretching direction, as the correlation of the components of the second oscillator ξ₂, “λ” and “λ_{R}” are habituation coefficients, and “K₂” is a feedback coefficient in accordance with the second motion oscillator φ₂.

The first function “f₁” is a linear function of the second intrinsic angular velocity ω₂ defined by a relational expression (032) with a positive coefficient c. The second function “f₂” is a quadratic function of the second intrinsic angular velocity ω₂ defined by a relational expression (033) with coefficients c₀, c₁, and c₂.

f₁(ω₂)≡cω₂ (032)

f₂(ω₂)≡c₀ω₂+c₁ω₂+c₂ω₂² (033)

The second oscillator ξ₂ᵢ is equal to zero when the value of the state variable uᵢ is smaller than a threshold value uₜₕ and is equal to the value of uᵢ when the value of the state variable uᵢ is equal to or greater than the threshold value uₜₕ. Alternatively, the second oscillator ε₂ᵢ is defined by a sigmoid function fs (See the relational expression (030)). Thereby, if the state variable u_{L+} representing the behavior of the left thigh toward the forward direction increases, the amplitude of the left bending component ξ_{2L+} of the second oscillator ξ₂ becomes greater than that of the left stretching component ξ_{2L-}; if the state variable u_{R+} representing the behavior of the right thigh toward the forward direction increases, the amplitude of the right bending component ξ_{2R+} of the second oscillator ξ₂ becomes greater than that of the right stretching component ξ_{2R-}.

Further, if the state variable u_{L-} representing the behavior of the left thigh toward the backward direction increases, the amplitude of the left stretching component ξ_{2L-} of the second oscillator ξ₂ becomes greater than that of the left bending component ξ_{2L+}; if the state variable u_{R-} representing the behavior of the right thigh toward the backward direction increases, the amplitude of the right stretching component ξ_{2R-} of the second oscillator 4₂ becomes greater than that of the right bending component ξ_{2R+}. The forward or backward motion of the leg (thigh) is identified by, for example, the polarity of the hip joint angular velocity.

Thereafter, the control command signal generating element 250 sets a control command signal η=(η_{L}, η_{R}) according to, for example, a relational expression (040) on the basis of the second oscillator ξ₂ (FIG. 3, STEP 110).

η_{L}=χ_{L+}ξ_{2L+}−χ_{L-}ξ_{2L-}, η_{R}=χ_{R+}ξ_{2R+}−χ_{R-}ξ_{2R-} (040)

The left component η_{L} of the control command signal η is calculated as a sum of a product of the left bending component ξ_{2L+} of the second oscillator ξ₂ and the coefficient χ₊ and a product of the left stretching component ξ_{2L-} of the second oscillator ξ₂ and the coefficient χ_{L-}. The right component η_{R} of the control command signal η is calculated as a sum of a product of the right bending component ξ_{2R+} of the second oscillator ξ₂ and the coefficient χ_{2R+} and a product of the right stretching component ξ_{2R-} of the second oscillator ξ₂ and the coefficient χ_{R-}.

As disclosed in Japanese Patent No. 4272711 by the present applicant or the like, the control command signal 11 may be generated so as to represent one or both of the elastic force of a virtual elastic element and the damping force of a virtual damping element.

Then, the controller 20 adjusts the current I=(I_{L}, I_{R}) supplied from the battery to the left and right actuators 14 on the basis of the control command signal η. This enables an adjustment of a torque tq=(tq_{L}, tq_{R}) assisting the waist (a first body part) and the thigh (a second body part) in a relative motion around the hip joint via the first orthosis 11 and the second orthosis 12. The torque tq is represented by, for example, tq(t)=G·I(t) (G: proportionality coefficient) on the basis of current I₁. The walking motion of the agent may be performed on a treadmill.

Further, the guidance signal generating element 280 causes the audio output device (guidance signal output device) 16 to intermittently output a guidance signal in synchronization with a change with time of the first oscillator ξ₁ (FIG. 3, STEP 112).

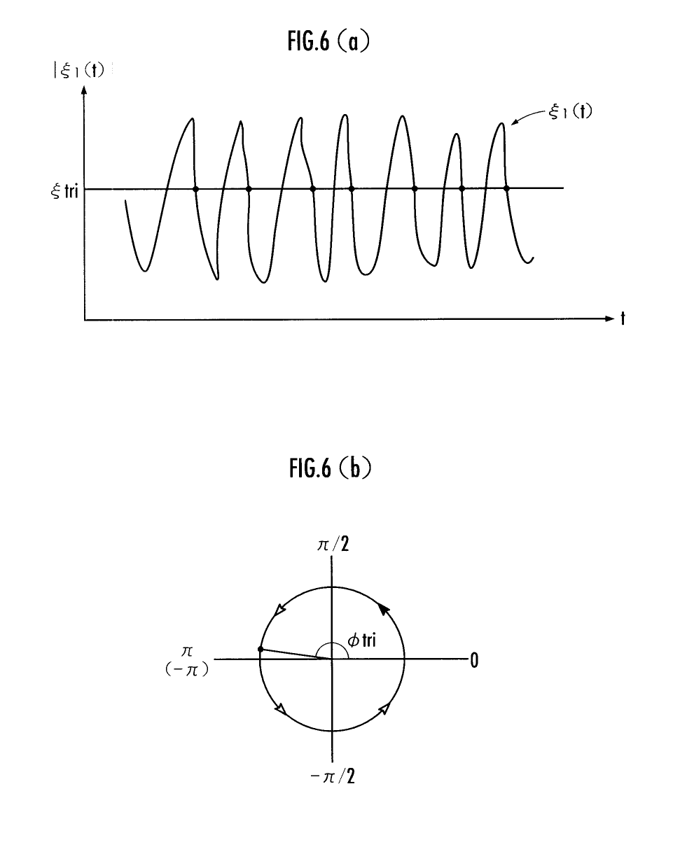

Thereby, for example, if the first oscillator ξ₁ changes with time t as illustrated in FIG. 6(a), an audible sound is output from the audio output device 16 at the time when the first oscillator ξ₁ reaches a reference value ξₜᵣᵢ during a decrease in the absolute value |ξ₁| of the first oscillator ξ₁. In addition, at the time when the phase of the first oscillator ξ₁ reaches a reference phase φₜᵣᵢ as illustrated in FIG. 6(b), an audible sound is output from the audio output device 16.

Thereafter, it is determined whether the operation termination condition is satisfied such that the operation switch is turned from ON to OFF or that an abnormal operation is detected (FIG. 3, STEP 114). Then, if the determination result is negative (FIG. 3, STEP 114 [NO]), the series of processes are repeated. On the other hand, if the determination result is affirmative (FIG. 3, STEP 114 [YES]), the series of processes end.

(Method of Adjusting Value of Sustained Energy Input Term)

The following describes a method of adjusting the value of the sustained energy input term ζ₀ contained in the simultaneous differential equation (030) representing the second model (See FIG. 3, STEP 200).

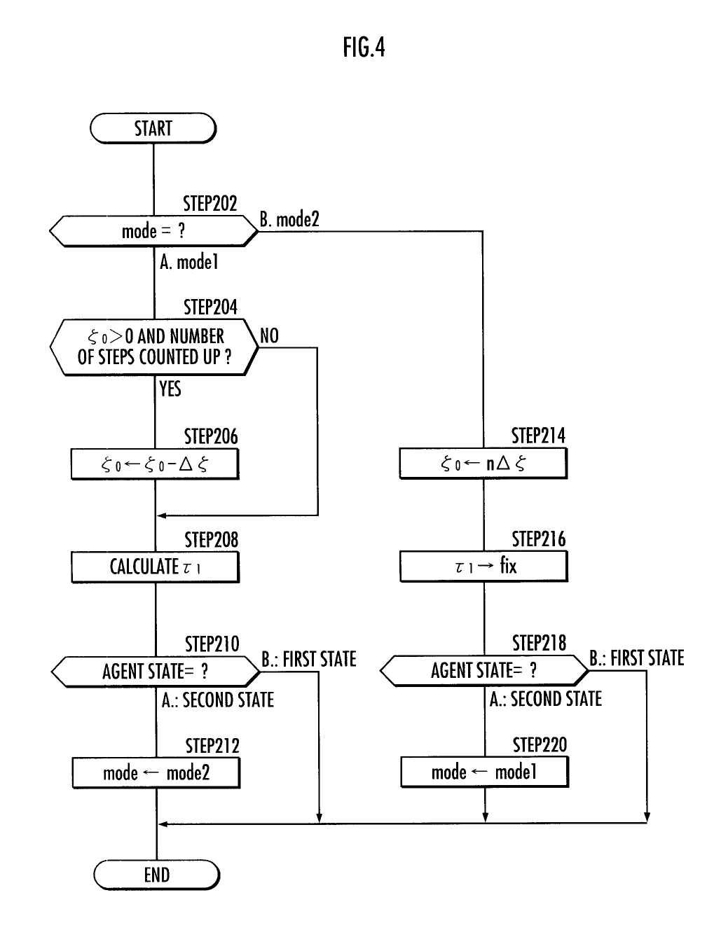

First, it is determined which of the first mode and the second mode is the operation mode of the walking motion assisting device 1 (FIG. 4, STEP 202). The first mode is an operation mode corresponding to a first state in which the agent is moving a leg. On the other hand, the second mode is an operation mode corresponding to a second state in which the leg motion of the agent is stagnant due to freezing of gait or the like.

At the start of the operation (when the operation switch is turned from OFF to ON), the operation mode of the walking motion assisting device 1 is set to the first mode, where the sustained energy input term ζ₀ is preset to an initial value 0.

If it is determined that the operation mode of the walking motion assisting device 1 is in the first mode (FIG. 4, STEP 202 [A]), it is further determined whether an assisting force decreasing condition is satisfied, where the assisting force decreasing condition is that the sustained energy input term ζ₀ is positive and the agent took a step (the number of steps was counted up) (FIG. 4, STEP 204).

The number of steps is counted up according to a sensor signal suggesting that the agent lands on the foot of the free leg (the leg lifted from the walking surface), such that, for example, the left hip joint angular velocity dψ_{L}/dt or the right hip joint angular velocity dψ_{R}/dt of the agent has shifted from an increase to a decrease on the bending side (forward), that the level of an output signal from a pressure sensor disposed on the sole has changed beyond a threshold value, or that the vertical component of an acceleration applied to the agent, which is represented by an output signal from the acceleration sensor provided on the waist or the like, has changed beyond the threshold value.

If it is determined that the assisting force decreasing condition is satisfied (FIG. 4, STEP 204 [YES]), the value of the sustained energy input term ζ₀ is decreased by Δζ (FIG. 4, STEP 206). Thereafter, the first time constant τ₁ is calculated according to a relational expression (031) on the basis of the second intrinsic angular velocity χ₂ (FIG. 4, STEP 208).

On the other hand, if it is determined that the assisting force decreasing condition is not satisfied (FIG. 4, STEP 204 [NO]), the value of the sustained energy input term ζ₀ is kept as it is and the first time constant τ₁ is calculated (FIG. 4, STEP 208).

Subsequently, a value detected by the sensor according to the leg motion of the agent is used as an index value to determine whether the agent is in the first state or the second state according to whether the index value remains within the specified range over time longer than a specified time period (FIG. 4, STEP 210).

For example, any of the following is used as the index value: a deviation between the left and right hip joint angles of the agent; the left and right hip joint angular velocities of the agent; the floor reaction forces acting on the left and right legs of the agent; or the vertical components of acceleration acting on the agent. If the deviation between the left and right hip joint angles of the agent is used as the index value, for example, 3 [sec] is used as the specified time period and −20° to 20° is used as the specified range.

If it is determined that the agent is in the second state (FIG. 4, STEP 210 [A]), the operation mode of the walking motion assisting device 1 effective during the time period until the number of steps is counted up next is set to the second mode (FIG. 4, STEP 212).

On the other hand, if it is determined that the agent is in the first state (FIG. 4, STEP 210 [B]), processes subsequent to the determination of the operation mode of the walking motion assisting device 1 (See FIG. 4, STEP 202) are performed.

If it is determined that the operation mode of the walking motion assisting device 1 is in the second mode (FIG. 4, STEP 202 [B]), the sustained energy input term ζ₀ is set to a value nΔζ at which the second oscillator ξ₂ self-oscillates (FIG. 4, STEP 214). In addition, the first time constant τ₁ is fixed to the adjacent value or a predetermined value independently of the second intrinsic angular velocity ω₂ (FIG. 4, STEP 216).

Subsequently, a value detected by the sensor according to the leg motion of the agent is used as an index value to determine whether the agent is in the first state or the second state according to whether the index value remains within the specified range over time longer than the specified time period (FIG. 4, STEP 218).

If it is determined that the agent is in the second state (FIG. 4, STEP 218 [A]), the operation mode of the walking motion assisting device 1 effective during the time period until the number of steps is counted up next is set to the first mode (FIG. 4, STEP 220).

On the other hand, if it is determined that the agent is in the first state (FIG. 4, STEP 218 [B]), processes subsequent to the determination of the operation mode of the walking motion assisting device 1 are performed (See FIG. 4, STEP 202).

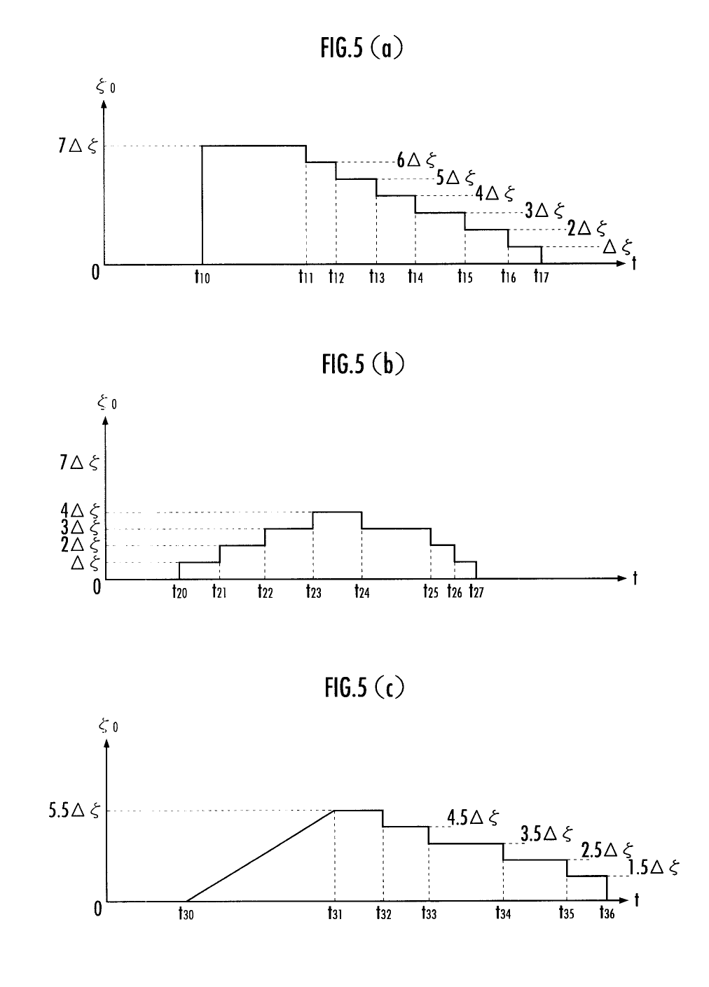

According to the setting method, the value of the sustained energy input term ζ₀ changes, for example, as illustrated in FIG. 5(a). The time interval between time t=t₁ₖ and time t=t₁ₖ₊₁ (k=1 to 6) is shorter than the specified time period.

First, in response to that the leg motion of the agent is stagnant, the sustained energy input term ζ₀ is set to, for example, 7Δζ(n=7) at time t=t₁₀ (See FIG. 4, STEP 210 [A]→STEP 212→STEP 202 [B]→STEP 214).

Thereafter, in response to that the agent moves a leg and takes a step, the sustained energy input term ζ₀ is decreased by Δζ at time t=t₁₁ to be set to 6Δζ (See FIG. 4, STEP 218 [A]→STEP 220→STEP 202 [A]→STEP 204 [YES]→STEP 206).

Every time the agent takes a step, the sustained energy input term ζ₀ is decreased by Δζ at each of time t=t₁₂ to t₁₇ (See FIG. 4, STEP 202 [A]→STEP 204 [YES]→STEP 206).

As described above, the level of the value of the sustained energy input term ζ₀ is a factor for determining the magnitude of the amplitude of the second oscillator ξ₂ and therefore is also a factor for determining the magnitude of the assisting force for the leg motion of the agent made by the actuator 14. Therefore, if the value of the sustained energy input term ζ₀ is adjusted as illustrated in FIG. 5(a), the assisting force is intensified at time t=t₁₀ and then reduced stepwise at each of time t=t₁₁ to t₁₇.

For example, if the time interval between time t=t₁ₖ and time t=t₁ₖ₊₁, that is, the elapsed time after the agent takes the last step is equal to or longer than the specified time, a transition from the first state to the second state is detected and the sustained energy input term ζ₀ is increased up to 7Δζ again in the course of the reduction.

(Operation and Effect of Walking Motion Assisting Device)

According to the walking motion assisting device 1 that implements the above functions, an oscillation signal changing with time in response to the leg motion of the agent is detected as the second motion oscillator φ₂ (See FIG. 3, STEP 102). Moreover, the second motion oscillator φ₂ is input to the second model, by which the second oscillator ξ₂ is generated (See FIG. 3, STEP 108). Then, a control command signal is generated based on the second oscillator ξ₂ and the operation of the actuator 14 is controlled according to the signal (See FIG. 3, STEP 110).

This enables the control of a force for assisting the leg motion of the agent while maintaining harmonization between a motion cycle or a rate of phase change of the leg of the agent and an operation cycle or a rate of phase change of the actuator 16.

Moreover, it is determined, based on a value detected in response to the leg motion of the agent, whether the leg motion of the agent is in the first state in which the leg of the agent is moving or in the second state in which the leg of the agent is stagnant (See FIG. 4, STEP 210 and STEP 218). Then, if the transition from the first state to the second state is detected as the determination result, the value of the sustained energy input term ζ₀ contained in the simultaneous differential equation (030) representing the second model is increased (See FIG. 4, STEP 210 [A]→STEP 212→STEP 202 [B]→STEP 214 and FIG. 5(a), t=t₁₀).

This intensifies the output from the actuator 16 for assisting the leg motion in response to that the leg motion of the agent is stagnant due to freezing of gait or the like. Therefore, even in the case where the leg motion of the agent is stagnant, the walking motion assisting device 1 is able to assist the agent in taking a step.

Further, with a requirement that the determination result obtained by the state monitoring element 260 indicates a transition from the second state to the first state, the value of the sustained energy input term ζ₀ is decreased. Every time it is determined that the agent took a step, the value of the sustained energy input term ζ₀ is decreased stepwise (See FIG. 4, STEP 218 [A]→STEP 220→STEP 202 [A]→STEP 204 [YES]→STEP 206 and FIG. 5(a), t=t₁₁ to t₁₇).

This reduces the force for assisting the leg motion stepwise every time the agent moves the leg as described above and takes a step. Therefore, a rapid change is inhibited in the force for assisting the leg motion of the agent, thereby avoiding a situation where the agent feels uncomfortable about the operation of the walking motion assisting device 1.

Moreover, a sound is output in synchronization with the first oscillator ξ₁ (See FIG. 3, STEP 112 and FIG. 6). This enables the agent to be aware of walking motion with the periodic motion of each leg of the agent or encourages the agent to perform the walking motion. Therefore, even if the motion of a leg of the agent is stagnant, the walking motion assisting device 1 is able to assist the agent while encouraging the agent to take a step with the leg.

### OTHER EMBODIMENTS OF THE PRESENT INVENTION

The walking motion assisting device 1 may be used to assist an animal other than a human such as a monkey, dog, horse, or cow in walking motion, as an agent in walking motion.

If the determination result obtained by the state monitoring element 260 indicates the transition from the first state to the second state, the energy adjusting element 270 may be configured to increase the value of the sustained energy input term continuously or stepwise until it is determined that the agent took a step.

According to the walking motion assisting device having the above configuration, a force for assisting the leg motion is increased continuously or stepwise during a time period after the leg motion of the agent is stopped and until the agent takes a step with the leg.

The value of the sustained energy input term ζ₀ changes, for example, as illustrated in FIG. 5(b). The time interval between time t=t₂ₖ and time t=t₂ₖ₊₁ (k=4 to 6) is shorter than the specified time period.

First, in response to that the leg motion of the agent is stagnant, the sustained energy input term ζ₀ is set to Δζ at time t=t₁₀ (See FIG. 4, STEP 210 [A]→STEP 212→STEP 202 [B]→STEP 214).

Thereafter, until it is detected that the agent took a step, the sustained energy input term ζ₀ is increased by Δζ. This diagram illustrates a state where the sustained energy input term ζ₀ is further increased by Δζ in each of three steps from time t=t₂₁ to t=t₂₃.

Moreover, in response to that the agent moves a leg and takes a step, the sustained energy input term ζ₀ is decreased by Δζ at time t=t₂₄ to be set to 3Δζ (See FIG. 4, STEP 218 [A]→STEP 220→STEP 202 [A]→STEP 204 [YES]→STEP 206).

Then, every time the agent takes a step, the sustained energy input term ζ₀ is decreased by Δζ at each of time t=t₂₅ to t₂₇ (See FIG. 4, STEP 202 [A]→STEP 204 [YES]→STEP 206).

In addition, the value of the sustained energy input term ζ₀ changes as illustrated in FIG. 5(c). The time interval between time t=t₃ₖ and t=t₃ₖ₊₁ (k=1 to 5) is shorter than the specified time period.

First, in response to that the leg motion of the agent is stagnant, the increase of the sustained energy input term ζ₀ is started at time t=t₃₀. Thereafter, until it is detected that the agent took a step, the sustained energy input term ζ₀ is continuously increased. This diagram illustrates that the sustained energy input term ζ₀ is increased from zero to up to 5.5 Δζ during a time interval between time t=t₃₀ to t₃₁.

Further, in response to that the agent moves a leg and takes a step, the sustained energy input term ζ₀ is decreased by Δζ at time t=t₃₂ to be set to 4.5 Δζ (See FIG. 4, STEP 218 [A]→STEP 220→STEP 202 [A]→STEP 204 [YES]→STEP 206).

Then, every time the agent takes a step, the sustained energy input term ζ₀ is decreased stepwise at each of time t=t₃₃ to t₃₆, such as, for example, 4.5 Δζ→3.5 Δζ→2.5 Δζ→1.5 Δζ→0 (See FIG. 4, STEP 202 [A]→STEP 204 [YES]→STEP 206).

Since the level of the value of the sustained energy input term ζ₀ is a factor for determining the magnitude of the amplitude of the second oscillator ξ₂ and therefore is also a factor for determining the magnitude of the assisting force for the leg motion of the agent with the actuator 14. Therefore, if the value of the sustained energy input term ζ₀ is adjusted as illustrated in FIGS. 5(b) and 5(c), a rapid change is inhibited in the force for assisting the leg motion of the agent, thereby avoiding a situation where the agent feels uncomfortable about the operation of the walking motion assisting device 1. In addition, the agent is able to be assisted in moving the stagnant leg with a force having just enough strength to take a step forward.

The energy adjusting element 270 may be configured so that the longer a time interval between the last time's clock time and the current time's clock time when the agent took a step under the condition that the time interval is less than the specified time, the less the value of the sustained energy input term ζ₀ is decreased.

According to the walking motion assisting device 1 having the above configuration, an excessive reduction of the force for assisting the leg motion is avoided in a situation where it is presumed that the agent has trouble in taking a step. For example, although the value of the sustained energy input term ζ₀ uniformly decreases by Δζ in FIG. 5(a), the decrease at time t=t₁₃ is adjusted to be smaller than the decrease at time t=t₁₂ if t₁₂−t₁₁<t₁₃−t₁₂. This enables the assistance for the leg motion to be continued with a force having appropriate strength for the agent to take a step in that situation.

In synchronization with the change with time of the second oscillator ξ₂, instead of the first oscillator ξ₁, the guidance signal may be intermittently output (See FIG. 6).

The walking motion assisting device 1 having the above configuration is capable of causing the agent to be aware of walking motion with the periodic motion of each leg of the agent or encouraging the agent to perform the walking motion. Therefore, even if the motion of a leg of the agent is stagnant, the walking motion assisting device 1 is able to assist the agent while encouraging the agent to take a step with the leg.

Instead of or in addition to the intermittent sound output (See FIG. 3, STEP 112), a light source such as an LED may be intermittently turned on in a field-of-view range of the agent and temporary vibration may be applied to a body part of the agent or an intermittent electrical stimulation signal may be applied to the legs of the agent.

With the omission of the detection of the first motion oscillator φ₁ (See FIG. 3, STEP 102) and of the generation of the first oscillator ξ₁ (See FIG. 3, STEP 104), the second oscillator ξ₂ may be generated after the second intrinsic angular velocity ω₂ is set according to the level of the hip joint angular velocity, the level of the walking speed, or the length of the walking period.

What is claimed is:

1. A walking motion assisting device, having a first orthosis and a second orthosis to be attached to the body and thigh of an agent, respectively, an actuator, and a controller, which controls the amplitude and phase of an output from the actuator, the walking motion assisting device assisting the agent in walking motion by assisting a motion around a hip joint of the thigh relative to the body of the agent, via the first orthosis and the second orthosis, by the output from the actuator,
wherein the controller includes:
a motion oscillator detecting element configured to detect an oscillation signal that changes with time in response to a periodic motion of a leg of the agent, as a second motion oscillator;
a second oscillator generating unit configured to generate a second oscillator as an output oscillation signal by inputting, as an input oscillation signal, the second motion oscillator detected by a motion oscillator detecting element to a second model, which is defined by a simultaneous differential equation having a plurality of state variables representing a motion state of the agent to generate the output oscillation signal that changes with time according to an amplitude corresponding to a value of a sustained energy input term contained in the simultaneous differential equation and an angular velocity determined based on a second intrinsic angular velocity, on the basis of the input oscillation signal;
a control command signal generating element, which generates a control command signal to the actuator on the basis of the second oscillator;
a state monitoring element configured to determine whether the agent is in a first state in which the agent is moving the leg or a second state in which a leg motion of the agent is stagnant according to whether an index value remains within a specified range over time longer than a specified time period where the index value is a value detected by a sensor in response to the leg motion of the agent; and
an energy adjusting element configured to increase the value of the sustained energy input term with a requirement that the determination result obtained by the state monitoring element indicates a transition from the first state to the second state.

2. The walking motion assisting device according to claim 1, wherein:
the state monitoring element is configured to further determine whether the agent took a step;
in the case where the determination result obtained by the state monitoring element indicates the transition from the first state to the second state, the energy adjusting element is configured to increase the value of the sustained energy input term continuously or stepwise until the state monitoring element determines that the agent took a step.

3. The walking motion assisting device according to claim 1, wherein the energy adjusting element is configured to decrease the value of the sustained energy input term with a requirement that the determination result obtained by the state monitoring element indicates a transition from the second state to the first state.

4. The walking motion assisting device according to claim 3, wherein:
the state monitoring element is configured to further determine whether the agent took a step; and
the energy adjusting element is configured to decrease the value of the sustained energy input term stepwise every time the state monitoring element determines that the agent took a step.

5. The walking motion assisting device according to claim 4, wherein the energy adjusting element is configured so that under the condition that a time interval between the last time's clock time and the current time's clock time when the agent took a step is less than the specified time period, the longer the time interval is, the less the value of the sustained energy input term is decreased.

6. The walking motion assisting device according to claim 1, further comprising a guidance signal output device, which outputs a signal recognizable by at least one of five senses of the agent or an electrical stimulation signal as a guidance signal, wherein:
the motion oscillator detecting element is configured to detect an oscillation signal that changes with time in response to the periodic motion of the leg of the agent, as a first motion oscillator; and
the controller includes:
a first oscillator generating element configured to generate a first oscillator as an output oscillation signal by inputting, as the input oscillation signal, the first motion oscillator detected by the motion oscillator detecting element to a first model for generating the output oscillation signal, which oscillates at an angular velocity determined based on a first intrinsic angular velocity by mutual entrainment with the input oscillation signal;
an intrinsic angular velocity setting unit configured to set an angular velocity of a second virtual oscillator as the second intrinsic angular velocity so that the second phase difference approximates to a desired phase difference according to a virtual model representing a first virtual oscillator and the second virtual oscillator, which oscillate with a second phase difference while interacting with each other on the basis of a first phase difference representing a correlation between the phase polarity of the first motion oscillator detected by the motion oscillator detecting element and the phase polarity of the first oscillator generated by the first oscillator generating unit; and
a motion guidance control element configured to cause the guidance signal output device to output the guidance signal intermittently in synchronization with a change with time of the first oscillator generated by the first oscillator generating element.

7. The walking motion assisting device according to claim 1, further comprising a guidance signal output device, which outputs a signal recognizable by at least one of five senses of the agent or an electrical stimulation signal as a guidance signal,
wherein the controller includes a motion guidance control element configured to cause the guidance signal output device to output the guidance signal intermittently in synchronization with a change with time of the second oscillator generated by the second oscillator generating element.
